(19) United States
(12) Patent Application Publication
(10) Pub. No.: US 2021/0142671 A1
(43) Pub. Date: May 13, 2021

(54) AUTOMATED VALET PARKING SYSTEM AND TERMINAL DEVICE

(71) Applicant: Toyota Jidosha Kabushiki Kaisha, Toyota-shi (JP)

(72) Inventors: Miyuki Takato, Toyota-shi (JP); Issei Matsunaga, Toyota-shi (JP)

(21) Appl. No.: 17/088,161

(22) Filed: Nov. 3, 2020

(30) Foreign Application Priority Data
Nov. 12, 2019 (JP) 2019-204584

(51) Int. Cl. G08G 1/14; G08G 1/127; G08G 1/133; G07B 15/02; G06Q 30/02

(52) U.S. Cl. CPC G08G 1/149; G08G 1/127; G06Q 30/0235; G07B 15/02; G08G 1/133

(57) ABSTRACT

An automated valet parking system manages automated valet parking in a parking lot, especially entry into and exit from the parking lot of a subject vehicle supporting the automated valet parking. Expected congestion information on the parking lot is information expected from a predetermined schedule, and indicates that at least one of entry into and exit from the parking lot of vehicles is expected to be more congested during a second hour than during a first hour. The automated valet parking system: receives request information indicating at least the parking lot specified by a user from a user's terminal device; refers to the expected congestion information on the specified parking lot in response to the request information to generate delivery information indicating at least one of the first hour and the second hour regarding the specified parking lot; and sends the delivery information to the user's terminal device.

### CROSS-REFERENCE TO RELATED APPLICATIONS

This application claims priority to Japanese Application No. 2019-204584 filed on Nov. 12, 2019, the entire contents of which are herein incorporated by reference.

### BACKGROUND

### Technical Field

The present disclosure relates to an automated valet parking system that manages automated valet parking (AVP: Automated Valet Parking) in a parking lot. In addition, the present disclosure relates to a terminal device operated by a user of the automated valet parking.

### Background Art

Patent Literature 1 discloses a management device for automated valet parking. The management device makes a vehicle travel autonomously to perform entry of the vehicle into a parking lot and exit of the vehicle from the parking lot. At the time of exit, the management device makes the vehicle travel autonomously from a parking space in the parking lot to a predetermined place. Moreover, the management device sets a maximum waiting time at the predetermined place. If the maximum waiting time elapses since the vehicle arrives at the predetermined place, the management device returns the vehicle from the predetermined place into the parking lot again.

### LIST OF RELATED ART

Patent Literature 1: Japanese Laid-Open Patent Publication No. JP-2019-067200

### SUMMARY

An automated valet parking system manages automated valet parking in a parking lot. For example, the automated valet parking system manages entry into the parking lot and exit from the parking lot of a subject vehicle supporting the automated valet parking.

Here, let us consider a situation where a large number of vehicles enter the parking lot or exit the parking lot during certain hours. During that peak hour, the large number of vehicles move simultaneously in the parking lot. If a timing of the entry or the exit of the subject vehicle supporting the automated valet parking overlaps with the peak hour, the automated valet parking system needs to manage the entry or the exit of the subject vehicle while considering movement of the large number of other vehicles in the parking lot. Moreover, if the entry or the exit of a large number of subject vehicles is concentrated during certain hours, the automated valet parking system needs to simultaneously manage the entry or the exit of the large number of subject vehicles. These lead to increase in processing load of the automated valet parking system.

An object of the present disclosure is to provide a technique contributing to reduction in processing load of an automated valet parking system that manages automated valet parking in a parking lot.

A first aspect is directed to an automated valet parking system that manages automated valet parking in a parking lot. The automated valet parking system includes: one or more processors configured to manage entry into the parking lot and exit from the parking lot of a subject vehicle supporting the automated valet parking; one or more memory devices configured to store expected congestion information on the parking lot; and a communication device configured to communicate with a terminal device operated by a user of the automated valet parking. The expected congestion information is information expected from a predetermined schedule, and indicates that at least one of entry of vehicles into the parking lot and exit of vehicles from the parking lot is expected to be more congested during a second hour than during a first hour. The one or more processors are further configured to: receive request information indicating at least the parking lot specified by the user from the terminal device through the communication device; refer to the expected congestion information on the specified parking lot in response to the request information to generate delivery information indicating at least one of the first hour and the second hour regarding the specified parking lot; and send the delivery information to the terminal device through the communication device.

A second aspect further has the following feature in addition to the first aspect. The delivery information further includes usage fee information on a usage fee of the specified parking lot. The usage fee information indicates that the usage fee of the specified parking lot is higher in a case where the entry or the exit of the subject vehicle is conducted during the second hour than in a case where the entry or the exit of the subject vehicle is conducted during the first hour.

A third aspect further has the following feature in addition to the first or second aspect. The delivery information further includes benefit information. The benefit information indicates that a benefit is given to the user when the entry or the exit of the subject vehicle is conducted during the first hour.

A fourth aspect further has the following feature in addition to the third aspect. The benefit includes a discount on a usage fee of the specified parking lot.

A fifth aspect further has the following feature in addition to the third or fourth aspect. The benefit includes a discount on a usage fee of a facility used by users of the specified parking lot.

A sixth aspect further has the following feature in addition to any one of the third to fifth aspects. The one or more processors are further configured to receive reservation information including a desired date of use, a desired entry time, and a desired exit time desired by the user from the terminal device through the communication device. The benefit for the user is enabled when the desired entry time or the desired exit time on the desired date of use is included in the first hour.

A seventh aspect further has the following feature in addition to any one of the first to sixth aspects. The one or more memory devices are further configure to store schedule information indicating the predetermined schedule. The one or more processors are further configured to expect the first hour the second hour by referring to the predetermined schedule indicated by the schedule information to generate the expected congestion information and store the expected congestion information in the one or more memory devices.

An eighth aspect further has the following feature in addition to any one of the first to seventh aspects. The parking lot is used by users of transportation or an event venue. The predetermined schedule is a schedule of the transportation or a schedule of an event at the event venue.

A ninth aspect is directed to a terminal device operated by a user of automated valet parking. An automated valet parking system managing the automated valet parking manages entry into the parking lot and exit from the parking lot of a subject vehicle supporting the automated valet parking. Expected congestion information is information expected from a predetermined schedule, and indicates that at least one of entry of vehicles into the parking lot and exit of vehicles from the parking lot is expected to be more congested during a second hour than during a first hour. The terminal device includes: a processor; a communication device configured to communicate with the automated valet parking system; and a display device. In accordance with an operation of the terminal device by the user, the processor of the terminal device generates request information indicating at least the parking lot specified by the user, and sends the request information to the automated valet parking system through the communication device. In response to the request information, the automated valet parking system refers to the expected congestion information on the specified parking lot to generate delivery information indicating at least one of the first hour and the second hour regarding the specified parking lot, and sends the delivery information to the terminal device. The processor of the terminal device receives the delivery information through the communication device and displays the delivery information on the display device.

According to the first aspect, the automated valet parking system provides an information delivery service. More specifically, the automated valet parking system receives the request information indicating at least the parking lot specified by the user from the terminal device. In response to the request information, the automated valet parking system refers to the expected congestion information on the specified parking lot to generate the delivery information, and sends the generated delivery information to the terminal device. The expected congestion information is information expected from a predetermined schedule, and indicates that at least one of entry of vehicles into the parking lot and exit of vehicles from the parking lot is expected to be more congested during the second hour than during the first hour. The delivery information indicates at least one of the first hour and the second hour regarding the specified parking lot.

The user knows at least one of the first hour and the second hour from the delivery information. The user knowing the second hour is likely to conduct the entry or the exit of the subject vehicle with avoiding the second hour. The user knowing the first hour is likely to conduct the entry or the exit of the subject vehicle during the first hour. To select the first hour means to avoid the second hour indirectly.

As described, the user provided with the delivery information is likely to directly or indirectly avoid the second hour. Due to a certain number of users being provided with the delivery information, congestion of the entry into the parking lot or the exit from the parking lot is expected to be reduced. In other words, a peak of a congestion degree of the entry or the exit is expected to be decreased. As a result, the processing load of the automated valet parking system that manages the entry and exit is reduced.

According to the second aspect, the delivery information includes the usage fee information. The usage fee information indicates that the usage fee of the specified parking lot is higher in a case where the entry or the exit of the subject vehicle is conducted during the second hour than in a case where the entry or the exit of the subject vehicle is conducted during the first hour. Therefore, the user's incentive to avoid the second hour is further increased. As a result, the effects due to the information delivery service are further increased.

According to the third to fifth aspects, the delivery information includes the benefit information. The benefit information indicates that a benefit is given to the user when the entry or the exit of the subject vehicle is conducted during the first hour. Therefore, the user's incentive to select the first hour is further increased. As a result, the effects due to the information delivery service are further increased.

According to the sixth aspect, the benefit is enabled if the user makes a reservation of the automated valet parking. Therefore, reservation of the automated valet parking is promoted. This is preferable in terms of management of the parking lot.

According to the seventh aspect, the expected congestion information is automatically generated by the automated valet parking system. Thus, a load of a system administrator is reduced.

According to the eighth aspect, the above-described effects are obtained with respect to the parking lot used by users of the transportation or the event venue. Since the transportation or the event venue is used by a large number of users, the above-described effects are especially preferable.

According to the ninth aspect, the same effects as in the first aspect are obtained.

### BRIEF DESCRIPTION OF DRAWINGS

FIG. 1 is a conceptual diagram for explaining an outline of an automated valet parking system according to an embodiment of the present disclosure;

FIG. 2 is a block diagram for explaining an outline of an information delivery service provided by the automated valet parking system according to the embodiment of the present disclosure;

FIG. 3 is a conceptual diagram for explaining an example of expected congestion information in the embodiment of the present disclosure;

FIG. 4 is a conceptual diagram for explaining another example of the expected congestion information in the embodiment of the present disclosure;

FIG. 5 is a conceptual diagram for explaining an effect due to the information delivery service according to the embodiment of the present disclosure;

FIG. 6 is a conceptual diagram for explaining an effect due to the information delivery service according to the embodiment of the present disclosure;

FIG. 7 is a conceptual diagram for explaining usage fee information in the embodiment of the present disclosure;

FIG. 8 is a flow chart summarizing processing related to the information delivery service according to the embodiment of the present disclosure;

FIG. 9 is a schematic diagram showing a configuration example of the automated valet parking system according to the embodiment of the present disclosure;

FIG. 10 is a block diagram showing a configuration example of the automated valet parking system according to the embodiment of the present disclosure; and

FIG. 11 is a block diagram showing a configuration example of a terminal device according to the embodiment of the present disclosure.

### DETAILED DESCRIPTION

Embodiments of the present disclosure will be described with reference to attached drawings.

### 1. Outline of Automated Valet Parking System

FIG. 1 is a conceptual diagram for explaining an outline of an automated valet parking system 100 according to the present embodiment. The automated valet parking system 100 manages “automated valet parking (AVP: Automated Valet Parking)” in a parking lot 10.

The parking lot 10 is at least used for parking of a vehicle supporting the automated valet parking. The vehicle supporting the automated valet parking is hereinafter referred to as a “subject vehicle 1.” The parking lot 10 may be also used for parking of general vehicles other than the subject vehicle 1.

The parking lot 10 includes a pick-up and drop-off area 11, a passage 12, and a plurality of parking spaces 13. The subject vehicle 1 to enter the parking lot 10 or the subject vehicle 1 that exits the parking lot 10 is stopped at the pick-up and drop-off area 11. At the pick-up and drop-off area 11, an occupant gets off the subject vehicle 1 and gets on the subject vehicle 1. The passage 12 is an area where vehicles such as the subject vehicle 1 and the general vehicle travels. Position references (e.g., markers) used for guiding the subject vehicle 1 may be installed on the passage 12. The parking space 13 is a space in which the vehicle such as the subject vehicle 1 and the general vehicle is parked. For example, the parking space 13 is partitioned by mark lines.

The subject vehicle 1 is able to travel without a driving operation of a driver at least in the parking lot 10. The subject vehicle 1 may be an automated driving vehicle.

Typically, the subject vehicle 1 is provided with a recognition function, a localization function, a vehicle travel control function, and a communication function. The recognition function recognizes a situation around the subject vehicle 1 and acquires “surrounding situation information” indicating the recognition result. For example, the recognition function uses a camera to recognize the position reference (e.g., markers and the like), the mark line, the passage 12, the parking space 13, other vehicles, structures, and so forth. The localization function determines a position and an orientation of the subject vehicle 1 in the parking lot 10, and acquires “position information” indicating the determined position and orientation. For example, the localization function compares map information on the parking lot 10 and the recognized position reference to determine the position and orientation of the subject vehicle 1. The vehicle travel control function controls travel (i.e., steering, acceleration, and deceleration) of the subject vehicle 1 without depending on a driving operation of a driver. For example, the vehicle travel control function is able to make the subject vehicle 1 autonomously travel to a destination based on the map information on the parking lot 10, the position information, and the surrounding situation information. The communication function communicates with the automated valet parking system 100. The subject vehicle 1 is realized by a processor of the subject vehicle 1 executing automated valet parking software.

The automated valet parking system 100 manages the automated valet parking. For example, the automated valet parking system 100 manages membership information of users of the automated valet parking. In addition, the automated valet parking system 100 grasps a utilization status (vacancy status, congestion status) of the parking lot 10. Moreover, the automated valet parking system 100 uses cameras and sensors installed in the parking lot 10 to monitor movements and states of the vehicles. Furthermore, the automated valet parking system 100 communicates with the subject vehicle 1. For example, the automated valet parking system 100 may remotely operate the subject vehicle 1 through communication. Furthermore, the automated valet parking system 100 manages entry of the subject vehicle 1 into the parking lot 10 and exit of the subject vehicle 1 from the parking lot 10. The management of the entry and exit also includes management of the automated travel of the subject vehicle 1 in the passage 12 in the parking lot 10.

Hereinafter, an example of a flow when a user X uses the automated valet parking will be described. It is assumed that the membership information of the user X is registered in advance in the automated valet parking system 100. In the following description, a “subject vehicle 1X” is the subject vehicle 1 on which the user X rides. A vehicle license number (i.e., a number on a license plate) of the subject vehicle 1X may also be registered in advance in the automated valet parking system 100 along with the membership information of the user X.

A terminal device 200 is a terminal device operated by the user X. The terminal device 200 may be owned by user X. Examples of the terminal device 200 include a smartphone, a tablet, a personal computer, an HMI (Human-Machine Interface) mounted on the subject vehicle 1X, and the like. The terminal device 200 is able to communicate with the automated valet parking system 100.

First, the user X makes a reservation of the automated valet parking. For example, the user X operates the terminal device 200 to input ID information of the user X, a desired parking lot 10, a desired date of use, a desired time of use (i.e., a desired entry time and a desired exit time), and the like. The user X may further input the vehicle license number of the subject vehicle 1X. The terminal device 200 sends reservation information including the input information to the automated valet parking system 100. The automated valet parking system 100 executes reservation processing based on the reservation information, and sends a reservation completion notification to the terminal device 200. In addition, the automated valet parking system 100 sends authentication information associated with the reservation information to the terminal device 200. The terminal device 200 receives the authentication information and holds the received authentication information.

The entry of the subject vehicle 1X into the parking lot 10 is as follows. The subject vehicle 1X with the user X arrives and stops at the pick-up and drop-off area 11 of the parking lot 10. At the pick-up and drop-off area 11, the user X (and other occupants if any) gets off the subject vehicle 1X. Then, the user X requests the entry of the subject vehicle 1X by using the authentication information held in the terminal device 200. For example, the user X sends the authentication information from the terminal device 200 to the automated valet parking system 100. Alternatively, the user X may make a reader installed in the pick-up and drop-off area 11 read the authentication information (e.g., a QR code (registered trademark)).

In response to the entry request, the automated valet parking system 100 conducts authentication of the user X. For example, the automated valet parking system 100 authenticates the user X by checking the authentication information against the reservation information. In addition, the automated valet parking system 100 may read the vehicle license number on the license plate of the subject vehicle 1X by using a camera installed in the pick-up and drop-off area 11. Then, the automated valet parking system 100 may authenticate the subject vehicle 1X by checking the read vehicle license number against the vehicle license number that is registered in advance or included in the reservation information.

Upon completion of the authentication, authority to operate the subject vehicle 1X is transferred from the user X to the automated valet parking system 100. The automated valet parking system 100 executes entry processing with regard to the subject vehicle 1X.

In the entry processing, the automated valet parking system 100 communicates with the subject vehicle 1X to activate the subject vehicle 1X (ignition ON).

Further, the automated valet parking system 100 refers to the utilization status of the parking lot 10 to allocate an available parking space 13 to the subject vehicle 1X. Then, the automated valet parking system 100 communicates with the subject vehicle 1X to provide the subject vehicle 1X with entry guiding information. The entry guiding information includes information of the allocated parking space 13 and the map information on the parking lot 10. The automated valet parking system 100 may specify a travel route from the pick-up and drop-off area 11 to the allocated parking space 13. In that case, the entry guiding information includes information of the specified travel route.

After that, the automated valet parking system 100 communicates with the subject vehicle 1X to permit the entry.

Upon receipt of the entry permit, the subject vehicle 1X initiates the vehicle travel control. More specifically, based on the position information and the entry guiding information, the subject vehicle 1X automatically travels on the passage 12 from the pick-up and drop-off area 11 to the allocated parking space 13 and automatically parks in the allocated parking space 13. At this time, the subject vehicle 1X may travel along the travel route specified by the automated valet parking system 100. The subject vehicle 1X may perform the vehicle travel control while avoiding a collision with other vehicles and the structure based on the surrounding situation information. The automated valet parking system 100 may communicate with the subject vehicle 1X to remotely control the travel of the subject vehicle 1X.

Upon completion of the parking, the subject vehicle 1X notifies the automated valet parking system 100 of the parking completion. Alternatively, the automated valet parking system 100 may use the sensor installed in the parking lot 10 to detect completion of the parking of the subject vehicle 1X. After the parking is completed, the automated valet parking system 100 communicates with the subject vehicle 1X to deactivate the subject vehicle 1X (ignition OFF). The automated valet parking system 100 holds the information of the parking space 13 of the subject vehicle 1X in association with the user X.

The exit of the subject vehicle 1X from the parking lot 10 is as follows. The user X requests the exit of the subject vehicle 1X by using the terminal device 200. The exit request includes the authentication information, information of the pick-up and drop-off area 11 specified by the user X, and the like. In response to the exit request, the automated valet parking system 100 conducts authentication of the user X and executes exit processing with regard to the subject vehicle 1X.

In the exit processing, the automated valet parking system 100 communicates with the subject vehicle 1X to activate the subject vehicle 1X (ignition ON).

Further, the automated valet parking system 100 communicates with the subject vehicle 1X to provide the subject vehicle 1X with exit guiding information. The exit guiding information includes information of the pick-up and drop-off area 11 specified by the user X and the map information on the parking lot 10. The automated valet parking system 100 may specify a travel route from the parking space 13 to the specified pick-up and drop-off area 11. In that case, the exit guiding information includes information of the specified travel route.

After that, the automated valet parking system 100 communicates with the subject vehicle 1X to permit the exit.

Upon receipt of the exit permit, the subject vehicle 1X initiates the vehicle travel control. More specifically, based on the position information and the exit guiding information, the subject vehicle 1X automatically travels on the passage 12 from the parking space 13 to the specified pick-up and drop-off area 11. At this time, the subject vehicle 1X may travel along the travel route specified by the automated valet parking system 100. The subject vehicle 1X may perform the vehicle travel control while avoiding a collision with other vehicles and the structure based on the surrounding situation information. The automated valet parking system 100 may communicate with the subject vehicle 1X to remotely control the travel of the subject vehicle 1X.

The subject vehicle 1X arrives and stops at the pick-up and drop-off area 11 specified by the user X. The authority to operate the subject vehicle 1X is transferred from the automated valet parking system 100 to the user X. The user X (and other occupants if any) gets on the subject vehicle 1X. The subject vehicle 1X start moving toward a next destination.

It should be noted that it is also possible to utilize the automated valet parking without making a reservation. In this case, the entry request includes information equivalent to the reservation information. In response to the entry request, the automated valet parking system 100 checks whether or not there is a parking space 13 available over the desired time of use. When there is an available parking space 13, the automated valet parking system 100 permits the use of the parking lot 10 by the user X.

From a viewpoint of management of the parking lot 10, it is desirable that each user of the automated valet parking makes a reservation. As described above, the reservation information includes the desired parking lot 10, the desired date of use, and the desired time of use. Based on the reservation information, the automated valet parking system 100 is able to predict a future usage status of each parking lot 10 to some extent.

### 2. Concentration of Entry and Exit

Typically, the parking lot 10 is used by users of a facility 30. Accordingly, the parking lot 10 is affiliated with the facility 30 or exists in the vicinity of the facility 30.

For example, the parking lot 10 is used by users of transportation. Examples of the transportation include trains, airplanes, ships, buses, and the like. Examples of the facility 30 associated with the transportation include stations, airports, ports, bus terminals, and the like.

As another example, the parking lot 10 is used by users of an event venue. Examples of events held at the event venues include sports, races, concerts, symposiums, fairs, exhibitions, and the like. Examples of the facility 30 as the event venue include sports-related facilities (e.g., ballparks, soccer grounds, etc.), race tracks, concert venues, conference centers, exhibition centers, art museums, museums, commercial facilities, and the like. It should be noted that the parking lot 10 used by the users of the event venue may be used by other people. For example, when soccer audiences use a parking lot 10 of a commercial facility in the vicinity of a soccer ground, the parking lot 10 of the commercial facility may also be used by others.

The transportation and the event venue each is used by a large number of users. Moreover, schedules of the transportation and the events are predetermined. As to the parking lot 10 used by the users of such the transportation or event venue, at least one of the entry and the exit is likely to be concentrated during certain hours.

For example, entry into a parking lot 10 of an airport is likely to be concentrated during certain hours before a scheduled departure time of an airplane. As another example, entry into a parking lot 10 of a soccer ground or a parking lot 10 near the soccer ground is likely to be concentrated during certain hours before a scheduled start time of a soccer game. As yet another example, exit from the parking lot 10 of the soccer ground or the parking lot 10 near the soccer ground is likely to be concentrated during hours immediately after a scheduled end time of the soccer game.

An hour in which at least one of the entry into the parking lot 10 and the exit from the parking lot 10 is concentrated (congested) is hereinafter referred to as a “peak hour (congestion hour).” It should be noted that “the entry into the parking lot 10” here means the entry of all types of vehicles including the subject vehicles 1 and general vehicles. Similarly, “the exit from the parking lot 10” here means the exit of all types of vehicles. Since at least one of the entry and the exit is concentrated during the peak hour, a large number of vehicles move simultaneously in the parking lot 10.

Let us consider a case where the above-described subject vehicle 1X enters that parking lot 10 or exits that parking lot 10 during the peak hour of that parking lot 10. The user X may be or may not be one of the users of the transportation or the event venue. In either case, a timing of the entry or the exit of the subject vehicle 1X overlaps with the peak hour. In this case, the automated valet parking system 100 needs to manage the entry or the exit of the subject vehicle 1X while considering movement of a large number of other vehicles in the parking lot 10. For example, the automated valet parking system 100 needs to determine a travel route of the subject vehicle 1X while considering movement of a large number of other vehicles in the parking lot 10. This leads to increase in processing load of the automated valet parking system 100.

Moreover, if the entry or the exit of a large number of subject vehicles 1 including the subject vehicle 1X is concentrated during the peak hour, the automated valet parking system 100 needs to simultaneously manage the entry or the exit of the large number of subject vehicles 1. This also leads to increase in the processing load of the automated valet parking system 100.

In view of the above, the present embodiment provides a technique that contributes to reduction in the processing load of the automated valet parking system 100. More specifically, the automated valet parking system 100 according to the present embodiment provides an “information delivery service” as described below.

### 3. Information Delivery Service

### 3-1. Outline

FIG. 2 is a block diagram for explaining an outline of the information delivery service provided by the automated valet parking system 100 according to the present embodiment.

Schedule information SCD indicates a predetermined schedule. For example, the schedule information SCD indicates a schedule of the transportation. Such the schedule information SCD is provided by a governing body of the transportation, the facility 30 related to the transportation, and the like. As another example, the schedule information SCD indicates a schedule of an event. Such the schedule information SCD is provided by an organizer of the event, the facility 30 at which the event is held, and the like.

Expected congestion information CON is information expected (predicted) from the predetermined schedule indicated by the schedule information SCD. For example, hours when the entry of vehicles into the parking lot 10 is concentrated and hours when it is not concentrated can be expected (predicted) from the predetermined schedule.

In the following description, a term “first hour P1” and a term “second hour P2” are used. The second hour P2 is an hour during which at least one of the entry of vehicles into the parking lot 10 and the exit of vehicles from the parking lot 10 is expected to be more congested (concentrated) as compared with the first hour P1. That is to say, the first hour P1 is an expected off-peak hour, and the second hour P2 is an expected peak hour. The first hour P1 and the second hour P2 are expected based on the predetermined schedule. The expected congestion information CON indicates that “at least one of the entry of vehicles into the parking lot 10 and the exit of vehicles from the parking lot 10 is expected to be more congested during the second hour P2 than during the first hour P1.”

FIG. 3 is a conceptual diagram for explaining an example of the expected congestion information CON with regard to the parking lot 10 used by users of the transportation. A horizontal axis represents time, and a vertical axis represents a congestion degree of the entry into the parking lot 10.

A scheduled departure time td of the transportation is predetermined and is acquired from the schedule information SCD. An hour PC is from a time t3 to the scheduled departure time td. An hour PB is prior to the hour PC and is from a time t2 to the time t3. An hour PA is prior to the hour PB and is from a time t1 to the time t2.

The entry into the parking lot 10 is expected to be congested in the hour PC close to the scheduled departure time td. In other words, a peak of the congestion degree of the entry is expected to exist in the hour PC close to the scheduled departure time td. On the other hand, in the hour PA far from the scheduled departure time td, the congestion degree is expected to be low. The congestion degree in the hour PB is expected to be higher than that in the hour PA and lower than that in the hour PC. Therefore, the hour PA is the first hour P1. The hour PC including the peak of the congestion degree is the second hour P2. The hour PB is the second hour P2 when compared to the hour PA, and is the first hour P1 when compared to the hour PC.

FIG. 4 is a conceptual diagram for explaining an example of the expected congestion information CON with regard to the parking lot 10 used by users of the event venue. A horizontal axis represents time, and a vertical axis represents a congestion degree of the entry into the parking lot 10 or the exit from the parking lot 10.

A scheduled start time ts and a scheduled end time te of the event are predetermined and are acquired from the schedule information SCD. An hour PB is from a time t2 to the scheduled start time ts. An hour PA is prior to the hour PB and is from a time t1 to the time t2. An hour PC is from the scheduled start time ts to the scheduled end time te. An hour PD is from the scheduled end time te to a time t3. An hour PE is after the hour PD and is from the time t3 to a time t4.

The entry into the parking lot 10 is expected to be congested in the hour PB immediately before the scheduled start time ts. In other words, a peak of the congestion degree of the entry is expected to exist in the hour PB immediately before the scheduled start time ts. On the other hand, in the hour PA far from the scheduled start time ts, the congestion degree is expected to be low. In addition, in the hour PC immediately after the scheduled start time ts, the congestion degree is expected to be low. Therefore, the hour PA and the hour PC each is the first hour P1. The hour PB including the peak of the congestion degree is the second hour P2.

The exit from the parking lot 10 is expected to be congested in the hour PD immediately after the scheduled end time te. In other words, a peak of the congestion degree of the exit is expected to exist in the hour PD immediately after the scheduled end time te. On the other hand, in the hour PE far from the scheduled end time te, the congestion degree is expected to be low. In addition, in the hour PC before the scheduled end time te, the congestion degree is expected to be low. Therefore, the hour PE and the hour PC each is the first hour P1. The hour PD including the peak of the congestion degree is the second hour P2.

As shown in FIGS. 3 and 4, there is a certain relationship (pattern) between the schedule and the expected congestion degree. It is therefore possible to expect (predict), based on the schedule information SCD, the first hour P1 and the second hour P2 and to generate the expected congestion information CON. For example, in the case of the example shown in FIG. 3, the second hour P2 is an hour of a constant width α before the scheduled departure time td, the first hour P1 is an hour of a constant width β before the second hour P2. The constant widths α and β are predetermined for each transportation.

The automated valet parking system 100 acquires the schedule information SCD. Then, the automated valet parking system 100 expects the first hour P1 and the second hour P2 by referring to the schedule indicated by the schedule information SCD to generate the expected congestion information CON. The expected congestion information CON thus generated is stored in a memory device of the automated valet parking system 100. Alternatively, a system administrator may generate the expected congestion information CON by referring to the schedule information SCD and store the generated expected congestion information CON in the memory device of the automated valet parking system 100.

Referring again to FIG. 2, a situation where the user X uses the information delivery service provided by the automated valet parking system 100 will be described.

The user X operates the terminal device 200 to specify a parking lot 10 the user X desires to use. The user X may further specify a desired date of use. The terminal device 200 generates request information REQ in accordance with the operation performed by the user X. The request information REQ indicates at least the parking lot 10 specified by the user X. The request information REQ may further indicate the desired date of use specified by the user X. The terminal device 200 sends the request information REQ to the automated valet parking system 100.

The automated valet parking system 100 receives the request information REQ from the terminal device 200. In response to the request information REQ, the automated valet parking system 100 acquires the expected congestion information CON on the parking lot 10 specified by the user X. For example, when the expected congestion information CON is generated in advance and stored in the memory device, the automated valet parking system 100 reads the expected congestion information CON from the memory device. Alternatively, the automated valet parking system 100 may generate the expected congestion information CON from the schedule information SCD in response to the request information REQ.

Furthermore, the automated valet parking system 100 generates delivery information INF by referring to the expected congestion information CON acquired. The delivery information INF indicates at least one of the first hour P1 and the second hour P2 regarding the parking lot 10 specified by the user X. When the request information REQ includes the desired date of use, the delivery information INF indicates at least one of the first hour P1 and the second hour P2 on the desired date of use. Then, the automated valet parking system 100 sends the generated delivery information INF to the terminal device 200.

The terminal device 200 receives the delivery information INF from the automated valet parking system 100. The terminal device 200 provides the received delivery information INF to the user X. Typically, the terminal device 200 includes a display device and displays the delivery information INF on the display device.

The user X knows at least one of the first hour P1 (i.e., the expected off-peak hour) and the second hour P2 (i.e., the expected peak hour) from the delivery information INF. The information of the first hour P1 or the second hour P2 is useful to the user X. For example, the user X knowing the second hour P2 can plan to conduct the entry or the exit of the subject vehicle 1X with avoiding the second hour P2. The user X knowing the first hour P1 can plan to conduct the entry or the exit of the subject vehicle 1X during the first hour P1. To select the first hour P1 means to avoid the second hour P2 indirectly. That is, the user X provided with the delivery information INF is likely to directly or indirectly avoid the second hour P2.

In addition, the user X can input the reservation information RSV by referring to the received delivery information INF. The reservation information RSV includes the desired parking lot 10, the desired date of use, the desired time of use (i.e., the desired entry time and the desired exit time), and the like. In particular, the user X can determine the desired entry time and the desired exit time with reference to the delivery information INF.

FIGS. 5 and 6 are conceptual diagrams for explaining an effect due to the information delivery service according to the present embodiment. FIG. 5 is a diagram similar to FIG. 3 described above and shows an effect in the case of the parking lot 10 used by the users of the transportation. FIG. 6 is a diagram similar to FIG. 4 described above and shows an effect in the case of the parking lot 10 used by the users of the event venue.

As described above, the user X provided with the delivery information INF is likely to directly or indirectly avoid the second hour P2 (i.e., the expected peak hour). Due to a certain number of users X being provided with the delivery information INF, the congestion of the entry into the parking lot 10 or the exit from the parking lot 10 is expected to be reduced as shown in FIGS. 6 and 6. In other words, the peak of the congestion degree of the entry or the exit is expected to be decreased. As a result, the processing load of the automated valet parking system 100 that manages the entry and exit is reduced.

### 3-2. Example of Delivery Information

### <Expected Congestion Information>

The delivery information INF indicates at least one of the first hour P1 and the second hour P2 regarding the parking lot 10 specified by the user X. For example, the delivery information INF indicates both the first hour P1 and the second hour P2 regarding the parking lot 10 specified by the user X. The delivery information INF may indicate the expected congestion degree (see FIGS. 3 and 4).

### <Usage Fee Information>

The delivery information INF may include “usage fee information” on a usage fee of the parking lot 10 specified by the user X.

FIG. 7 conceptually shows the use usage fee information. The usage fee information indicates that “the usage fee is higher in a case where the entry or the exit of the subject vehicle 1 is conducted during the second hour P2 than in a case where the entry or the exit of the subject vehicle 1 is conducted during the first hour P1.” For example, the usage fee information includes a message that “an extra usage fee is applied when the entry or the exit of the subject vehicle 1 is conducted in the second hour P2.” As another example, the usage fee information includes a message that “a reduced usage fee is applied when the entry or the exit of the subject vehicle 1 is conducted in the first hour P1.” The usage fee information may indicate the usage fee in each hour itself.

When the delivery information INF includes such the usage fee information, incentive for the user X to avoid the second hour P2 is further increased. As a result, the effects due to the information delivery service according to the present embodiment are further increased.

A setting example of the usage fee in the case of the example shown in the foregoing FIG. 3 will be described. The usage fee is a sum of a base fee (a valet usage fee) Fv and a parking fee Fp increasing according to a parking duration. When the entry of the subject vehicle 1 is conducted during the hour PB, the base fee Fv and the parking fee Fp per unit time are set to normal fees, respectively. When the entry of the subject vehicle 1 is conducted during the hour PC, the base fee Fv is set to be higher than the normal fee. When the entry of the subject vehicle 1 is conducted during the hour PA, the base fee Fv is set to be lower than the normal fee and the parking fee Fp up to the time t2 is exempted.

### <Benefit Information>

The delivery information INF may include “benefit information” together with or instead of the usage fee information. The benefit information indicates that “a benefit is given to the user X when the entry or the exit of the subject vehicle 1 is conducted during the first hour P1.”

For example, the benefit includes a discount on the usage fee of the parking lot 10 specified by the user X.

As another example, the benefit may include a discount on a usage fee of the facility 30 used by users of the parking lot 10 specified by the user X. For example, in a case of the parking lot 10 of an airport, the airport is the facility 30 and a usage fee of a store and the like in the airport is discounted. As another example, in a case where soccer audiences use the parking lot 10 of a commercial facility in the vicinity of a soccer ground, the commercial facility is the facility 30 and a usage fee of a store and the like in the commercial facility is discounted. For example, the benefits information includes a discount coupon.

When the delivery information INF includes such the benefit information, incentive for the user X to select the first P1 is further increased. As a result, the effects due to the information delivery service according to the present embodiment are further increased.

The benefit may be enabled only when the user X makes a reservation. More specifically, the user X inputs the reservation information RSV with reference to the delivery information INF. The reservation information RSV includes the desired date of use, the desired entry time, and desired exit time. The terminal device 200 sends the reservation information RSV to the automated valet parking system 100. The automated valet parking system 100 checks whether or not the desired entry time or the desired exit time on the desired date of use is included in the first hour P1. When the desired entry time or the desired exit time is included in the first hour P1, the automated valet parking system 100 enables the benefit for the user X. As a result, the reservation of the automated valet parking is promoted.

The reservation of the automated valet parking being promoted is desirable from a viewpoint of management of the parking lot 10. The reason is that the automated valet parking system 100 is able to predict a future usage status of each parking lot 10 to some extent based on the reservation information RSV.

### 3-3. Processing Flow

FIG. 8 is a flow chart summarizing processing related to the information delivery service according to the present embodiment.

In Step S210, the terminal device 200 generates the request information REQ in accordance with an operation of the terminal device 200 by the user X. The request information REQ indicates at least the parking lot 10 specified by the user X. The terminal device 200 sends the request information REQ to the automated valet parking system 100.

In Step S110, the automated valet parking system 100 receives the request information REQ from the terminal device 200.

In Step S120, the automated valet parking system 100 acquires the expected congestion information CON on the parking lot 10 specified by the user X. For example, the automated valet parking system 100 reads the expected congestion information CON generated in advance from the memory device. Alternatively, the automated valet parking system 100 may generate the expected congestion information CON from the schedule information SCD.

In Step S130, the automated valet parking system 100 generates the delivery information INF based on the expected congestion information CON. The delivery information INF indicates at least one of the first hour P1 and the second hour P2 regarding the parking lot 10 specified by the user X. The delivery information INF may further include at least one of the usage fee information and the benefit information.

In Step S140, the automated valet parking system 100 sends the delivery information INF to the terminal device 200.

In Step S220, the terminal device 200 receives the delivery information INF from the automated valet parking system 100.

In Step S230, the terminal device 200 displays the delivery information INF on the display device.

In Step S240, the terminal device 200 generates the reservation information RSV in accordance with an operation of the terminal device 200 by the user X. The terminal device 200 sends the reservation information RSV to the automated valet parking system 100.

In Step S150, the automated valet parking system 100 receives the reservation information RSV from the terminal device 200 and registers it.

### 3-4. Effects

As described above, the automated valet parking system 100 according to the present embodiment provides the information delivery service. More specifically, the automated valet parking system 100 receives the request information REQ indicating at least the parking lot 10 specified by the user X from the terminal device 200. In response to the request information REQ, the automated valet parking system 100 refers to the expected congestion information CON on the specified parking lot 10 to generate the delivery information INF, and sends the generated delivery information INF to the terminal device 200. The delivery information INF indicates at least one of the first hour P1 (i.e., the expected off-peak hour) and the second hour P2 (i.e., the expected peak hour) regarding the specified parking lot 10.

The user X knows at least one of the first hour P1 and the second hour P2 from the delivery information INF. The user X knowing the second hour P2 is likely to conduct the entry or the exit of the subject vehicle 1X with avoiding the second hour P2. The user X knowing the first hour P1 is likely to conduct the entry or the exit of the subject vehicle 1X during the first hour P1. To select the first hour P1 means to avoid the second hour P2 indirectly.

As described, the user X provided with the delivery information INF is likely to directly or indirectly avoid the second hour P2. Due to a certain number of users X being provided with the delivery information INF, the congestion of the entry into the parking lot 10 or the exit from the parking lot is expected to be reduced. In other words, the peak of the congestion degree of the entry or the exit is expected to be decreased (see FIGS. 5 and 6). As a result, the processing load of the automated valet parking system 100 that manages the entry and exit is reduced.

The decrease in the peak of the congestion degree of the entry or the exit means that the number of vehicles moving simultaneously in the parking lot 10 is reduced. Therefore, a risk of a collision between vehicles in the parking lot 10 is reduced.

Moreover, the decrease in the peak of the congestion degree of the entry into the parking lot 10 means that congestion at a widow of the transportation or the event venues also is eliminated. For example, ticketing at the transportation or the event venues is dispersed. This is desirable for a governing body of the transportation and an organizer of the event.

In addition, the user X receiving the delivery information INF can input the reservation information RSV with reference to the delivery information INF. This improves convenience of the user X.

When the delivery information INF includes the usage fee information described above, the incentive for the user X to avoid the second hour P2 is further increased. When the delivery information INF includes the benefit information described above, the incentive for the user X to select the first P1 is further increased. As a result, the effects due to the information delivery service according to the present embodiment are further increased.

The information delivery service may be applied to the parking lot 10 used by users of the transportation or the event venue. Since the transportation or the event venue is used by a large number of users, the above-described effects are especially preferable.

### 4. Concrete Example of Automated Valet Parking System

### 4-1. Configuration Example

FIG. 9 is a schematic diagram showing a configuration example of the automated valet parking system 100 according to the present embodiment. The automated valet parking system 100 includes a vehicle management center 110, a control center 120, and a parking infrastructure 130.

The control center 120 is placed for each parking lot 10. Therefore, there are as many control centers 120 as the parking lots 10. The vehicle management center 110 controls all the control centers 120. In addition, the vehicle management center 110 manages the member information of the users of the automated valet parking.

The parking infrastructure 130 is an infrastructure of the parking lot 10. For example, the parking infrastructure 130 includes a gate, a sensor for detecting the vehicles, a camera for monitoring a situation and the vehicles in the parking lot 10, a reader installed in the pick-up and drop-off area 11, and the like.

FIG. 10 is a block diagram showing a concrete configuration example of the automated valet parking system 100 according to the present embodiment.

The vehicle management center 110 includes an information processing device 111 (a vehicle management server). The information processing device 111 includes a processor 112, a memory device 113, and a communication device 114. The processor 112 executes a variety of information processing by executing a computer program. A variety of information is stored in the memory device 113 (e.g., a volatile memory, a non-volatile memory, an HDD, an SSD, and the like). The communication device 114 (e.g., a communication circuitry, a network interface, a radio interface, and the like) communicates with the control center 120, the subject vehicle 1X, and the terminal device 200.

The control center 120 includes an information processing device 121 (a control device). The information processing device 121 includes a processor 122, a memory device 123, and a communication device 124. The processor 122 executes a variety of information processing by executing a computer program. A variety of information is stored in the memory device 123 (e.g., a volatile memory, a non-volatile memory, an HDD, an SSD, and the like). The communication device 124 (e.g., a communication circuitry, a network interface, a radio interface, and the like) communicates with the vehicle management center 110, the subject vehicle 1X, and the parking infrastructure 130.

Processing by the automated valet parking system 100 according to the present embodiment is executed by at least one of the processor 112 of the vehicle management center 110 and the processor 122 of the control center 120. That is, the processing by the automated valet parking system 100 according to the present embodiment is executed by one or more processors (112, 122). Moreover, information necessary for the processing is stored in at least one of the memory device 113 of the vehicle management center 110 and the memory device 123 of the control center 120. That is, the information necessary for the processing is stored in one or more memory devices (113, 123).

### 4-2. Processing Related to Information Delivery Service

The one or more processors (112, 122) of the automated valet parking system 100 execute processing related to the information delivery service. For example, the processing related to the information delivery service is as follows.

The schedule information SCD regarding a parking lot 10 is first input to the information processing device 121 of the control center 120 installed in the parking lot 10, and stored in the memory device 123. The processor 122 sends the schedule information SCD to the vehicle management center 110 through the communication device 124. The processor 112 of the vehicle management center 110 receives the schedule information SCD from the control center 120 of each parking lot 10 through the communication device 114. The processor 112 stores the schedule information SCD regarding each parking lot 10 in the memory device 113.

The processor 112 of the vehicle management center 110 generates the expected congestion information CON regarding each parking lot 10. That is, for each parking lot 10, the processor 112 expects (predicts) the first hour P1 and the second hour P2 by referring to the schedule information SCD to generate the expected congestion information CON. The processor 112 stores the expected congestion information CON regarding each parking lot 10 in the memory device 113.

As another example, the processor 122 of the control center 120 may expect (predict) the first hour P1 and the second hour P2 by referring to the schedule information SCD to generate the expected congestion information CON. In that case, the processor 122 stores the expected congestion information CON in the memory device 123 and also sends the expected congestion information CON to the vehicle management center 110 through the communication device 124. The processor 112 of the vehicle management center 110 receives the expected congestion information CON from the control center 120 of each parking lot 10 through the communication device 114. The processor 112 stores the expected congestion information CON regarding each parking lot 10 in the memory device 113.

As yet another example, a system administrator may generate the expected congestion information CON with reference to the schedule information SCD and store the generated expected congestion information CON in the memory device 113 or the memory device 123.

The processor 112 of the vehicle management center 110 receives the request information REQ from the terminal device 200 through the communication device 114 (FIG. 8, Step S110). In response to the request information REQ, the processor 112 acquires the expected congestion information CON regarding the parking lot 10 specified by the user X (FIG. 8, Step S120). For example, the processor 112 reads the expected congestion information CON that is generated in advance from the memory device 113. Alternatively, the processor 112 may generate the expected congestion information CON from the schedule information SCD at this timing.

Further, the processor 112 generates the delivery information INF by referring to the expected congestion information CON acquired (FIG. 8, Step S130). The delivery information INF indicates at least one of the first hour P1 and the second hour P2 regarding the parking lot 10 specified by the user X. The delivery information INF may further include at least one of the usage fee information and the benefit information. Then, the processor 112 sends the delivery information INF to the terminal device 200 through the communication device 114 (FIG. 8, Step S140).

### 4-3. Processing Related to Entry and Exit

The one or more processors (112, 122) of the automated valet parking system 100 manage the entry into the parking lot 10 and the exit from the parking lot 10 of the subject vehicle 1X.

First, the processor 112 of the vehicle management center 110 receives the reservation information RSV from the terminal device 200 through the communication device 114. The processor 112 stores the received reservation information RSV in the memory device 113. Moreover, the processor 112 sends the authentication information associated with the reservation information RSV to the terminal device 200 through the communication device 114.

Processing related to the entry of the subject vehicle 1X into the parking lot 10 is as follows.

The subject vehicle 1X with the user X arrives and stops at the pick-up and drop-off area 11 of the parking lot 10. The user X makes the reader installed in the pick-up and drop-off area 11 read the authentication information. The processor 122 of the control center 120 receives the authentication information from the parking infrastructure 130 (i.e., the reader) through the communication device 124. Then, the processor 122 sends the authentication information to the vehicle management center 110 through the communication device 124. The processor 112 of the vehicle management center 110 receives the authentication information from the control center 120 through the communication device 114. The processor 112 authenticates the user X by checking the authentication information against the reservation information RSV stored in the memory device 113.

In addition, the parking infrastructure 130 (i.e., the camera installed in the pick-up and drop-off area 11) may read the vehicle license number on the license plate of the subject vehicle 1X. The processor 122 of the control center 120 receives the read vehicle license number from the parking infrastructure 130 through the communication device 124. Then, the processor 122 notifies the vehicle management center 110 of the read vehicle license number through the communication device 124. The processor 112 of the vehicle management center 110 receives information of the vehicle license number from the control center 120 through the communication device 114. The processor 112 may authenticate the subject vehicle 1X by checking the read vehicle license number against the vehicle license number that is registered in advance or included in the reservation information RSV.

Upon completion of the authentication, the processor 112 communicates with the subject vehicle 1X through the communication device 114 to activate the subject vehicle 1X (ignition ON). Then, the processor 112 communicates with the control center 120 through the communication device 114 to instruct the control center 120 to execute the entry processing.

Utilization status information on the parking lot 10 is stored in the memory device 123 of the control center 120. The processor 122 of the control center 120 refers to the utilization status information to allocate an available parking space 13 to the subject vehicle 1X. The processor 122 stores information of the allocated parking space 13 in the memory device 123.

In addition, the map information on the parking lot 10 is stored in the memory device 123. The processor 122 communicates with the subject vehicle 1X through the communication device 124 to provide the subject vehicle 1 with the entry guiding information. The entry guiding information includes the information of the allocated parking space 13 and the map information on the parking lot 10. The processor 122 may specify a travel route from the pick-up and drop-off area 11 to the allocated parking space 13. In that case, the entry guiding information includes information of the specified travel route.

After that, the processor 122 communicates with the subject vehicle 1X through the communication device 124 to permit the entry. Based on the position information and the entry guiding information, the subject vehicle 1X automatically travels on the passage 12 from the pick-up and drop-off area 11 to the allocated parking space 13 and automatically parks in the allocated parking space 13. The processor 122 may communicate with the subject vehicle 1X and the parking infrastructure 130 through the communication device 124 to acquire the position information and status information on the subject vehicle 1X. Based on the position information and the status information on the subject vehicle 1X, the processor 122 may monitor the status of the subject vehicle 1X and remotely control the travel of the subject vehicle 1X as needed.

Upon completion of the parking, the subject vehicle 1X notifies the control center 120 of the parking completion. The processor 122 receives the parking completion notification from the subject vehicle 1X through the communication device 124. Then, the processor 122 transfers the parking completion notification to the vehicle management center 110 through the communication device 124.

The processor 112 of the vehicle management center 110 receives the parking completion notification from the control center 120 through the communication device 114. Then, the processor 112 communicates with the subject vehicle 1X through the communication device 114 to deactivate the subject vehicle 1X (ignition OFF).

Processing related to the exit of the subject vehicle 1X from the parking lot 10 is as follows.

The processor 112 of the vehicle management center 110 receives an exit request from the terminal device 200 through the communication device 114. In response to the exit request, the processor 112 communicates with the subject vehicle 1X through the communication device 114 to activate the subject vehicle 1X (ignition ON). Then, the processor 112 communicates with the control center 120 through the communication device 114 to instruct the control center 120 to execute the exit processing.

The processor 122 of the control center 120 communicates with the subject vehicle 1X through the communication device 124 to provide the subject vehicle 1X with the exit guiding information. The exit guiding information includes information of the pick-up and drop-off area 11 specified by the user X and the map information on the parking lot 10. The processor 122 may specify a travel route from the parking space 13 to the specified pick-up and drop-off area 11. In that case, the exit guiding information includes information of the specified travel route.

After that, the processor 122 communicates with the subject vehicle 1X through the communication device 124 to permit the exit. Based on the position information and the exit guiding information, the subject vehicle 1X automatically travels on the passage 12 from the parking space 13 to the specified pick-up and drop-off area 11. The processor 122 may communicate with the subject vehicle 1X and the parking infrastructure 130 through the communication device 124 to acquire the position information and the status information on the subject vehicle 1X. Based on the position information and the status information on the subject vehicle 1X, the processor 122 may monitor the status of the subject vehicle 1X and remotely control the travel of the subject vehicle 1X as needed. The subject vehicle 1X arrives and stops at the pick-up and drop-off area 11 specified by the user X.

### 5. Concrete Example of Terminal Device

FIG. 11 is a block diagram showing a configuration example of the terminal device 200 according to the present embodiment. The terminal device 200 includes a processor 210, a memory device 220, a communication device 230, an input device 240, and a display device 250.

The processor 210 executes a variety of information processing by executing a computer program. A variety of information is stored in the memory device 220 (e.g., a volatile memory, a non-volatile memory, and the like). The communication device 230 (e.g., a communication circuitry, a radio interface, and the like) communicates with the information processing device 111 of the vehicle management center 110. The input device 240 is used by the user X to input information. Examples of the input device 240 include a touch panel, a keyboard, a button, and the like. The display device 250 displays a variety of information. Examples of the display device 250 include a touch panel, a display, and the like.

An automated valet parking application APP is an application for utilizing the automated valet parking. The automated valet parking application APP is stored in the memory device 220 and executed by the processor 210. The processor 210 executes the automated valet parking application APP to execute a variety of information processing related to the automated valet parking. For example, the processing related to the information delivery service is as follows.

The processor 210 displays an information input screen on the display device 250. The user X operates the input device 240 to specify a parking lot 10 the user X desires to use, and so forth. In accordance with the operation of the input device 240 by the user X, the processor 210 generates the request information REQ indicating at least the specified parking lot 10. Then, the processor 210 sends the request information REQ to the information processing device 111 of the vehicle management center 110 through the communication device 230 (FIG. 8, Step S210).

After that, the processor 210 receives the delivery information INF from the information processing device 111 of the vehicle management center 110 through the communication device 230 (FIG. 8, Step S220). The processor 210 stores the received delivery information INF in the memory device 220. Further, the processor 210 displays the delivery information INF on the display device 250 (FIG. 8, Step S230).

Moreover, the processor 210 displays a reservation prompting screen on the display device 250. The user X operates the input device 240 to specify a desired date of use, a desired entry time, a desired exit time, and the like. The processor 210 generates the reservation information RSV in accordance with the operation of the input device 240 by user X. Then, the processor 210 sends the reservation information RSV to the information processing device 111 of the vehicle management center 110 through the communication device 230.

After that, the processor 210 receives the authentication information from the information processing device 111 of the vehicle management center 110 through the communication device 230. The processor 210 stores the received authentication information in the memory device 220. Further, the processor 210 displays the authentication information on the display device 250 as necessary.

### 6. Other Uses of Schedule Information

An hour when the entry into the parking lot 10 and the exit from the parking lot 10 are not requested is hereinafter referred to as a “stand-by hour.” For example, in a case of the parking lot 10 of an airport, hours from midnight to dawn when there is no arrival and departure of flights is the stand-by-hour.

The automated valet parking system 100 can grasp the stand-by hour based on the schedule information SCD. During the stand-by hour, the automated valet parking system 100 may suspend some functions in order to suppress power consumption. For example, the automated valet parking system 100 may suspend communications between the vehicle management center 110 and the control center 120. As another example, the automated valet parking system 100 may partially power off the parking lot 10 and the control center 120.

What is claimed is:

1. An automated valet parking system that manages automated valet parking in a parking lot, the automated valet parking system comprising:
one or more processors configured to manage entry into the parking lot and exit from the parking lot of a subject vehicle supporting the automated valet parking;
one or more memory devices configured to store expected congestion information on the parking lot; and
a communication device configured to communicate with a terminal device operated by a user of the automated valet parking, wherein
the expected congestion information is information expected from a predetermined schedule, and indicates that at least one of entry of vehicles into the parking lot and exit of vehicles from the parking lot is expected to be more congested during a second hour than during a first hour,
the one or more processors are further configured to:
receive request information indicating at least the parking lot specified by the user from the terminal device through the communication device;
refer to the expected congestion information on the specified parking lot in response to the request information to generate delivery information indicating at least one of the first hour and the second hour regarding the specified parking lot; and
send the delivery information to the terminal device through the communication device.

2. The automated valet parking system according to claim 1, wherein
the delivery information further includes usage fee information on a usage fee of the specified parking lot, and
the usage fee information indicates that the usage fee of the specified parking lot is higher in a case where the entry or the exit of the subject vehicle is conducted during the second hour than in a case where the entry or the exit of the subject vehicle is conducted during the first hour.

3. The automated valet parking system according to claim 1, wherein
the delivery information further includes benefit information, and
the benefit information indicates that a benefit is given to the user when the entry or the exit of the subject vehicle is conducted during the first hour.

4. The automated valet parking system according to claim 3, wherein
the benefit includes a discount on a usage fee of the specified parking lot.

5. The automated valet parking system according to claim 3, wherein
the benefit includes a discount on a usage fee of a facility used by users of the specified parking lot.

6. The automated valet parking system according to claim 3, wherein
the one or more processors are further configured to receive reservation information including a desired date of use, a desired entry time, and a desired exit time desired by the user from the terminal device through the communication device, and
the benefit for the user is enabled when the desired entry time or the desired exit time on the desired date of use is included in the first hour.

7. The automated valet parking system according to claim 1, wherein
the one or more memory devices are further configure to store schedule information indicating the predetermined schedule, and
the one or more processors are further configured to expect the first hour the second hour by referring to the predetermined schedule indicated by the schedule information to generate the expected congestion information and store the expected congestion information in the one or more memory devices.

8. The automated valet parking system according to claim 1, wherein
the parking lot is used by users of transportation or an event venue, and
the predetermined schedule is a schedule of the transportation or a schedule of an event at the event venue.

9. A terminal device operated by a user of automated valet parking in a parking lot, wherein
an automated valet parking system managing the automated valet parking manages entry into the parking lot and exit from the parking lot of a subject vehicle supporting the automated valet parking, and
expected congestion information is information expected from a predetermined schedule, and indicates that at least one of entry of vehicles into the parking lot and exit of vehicles from the parking lot is expected to be more congested during a second hour than during a first hour,
the terminal device comprising:
a processor;
a communication device configured to communicate with the automated valet parking system; and
a display device, wherein
in accordance with an operation of the terminal device by the user, the processor of the terminal device generates request information indicating at least the parking lot specified by the user, and sends the request information to the automated valet parking system through the communication device,
in response to the request information, the automated valet parking system refers to the expected congestion information on the specified parking lot to generate delivery information indicating at least one of the first hour and the second hour regarding the specified parking lot, and sends the delivery information to the terminal device, and
the processor of the terminal device receives the delivery information through the communication device and displays the delivery information on the display device.
